(19) United States
(12) Patent Application Publication
(10) Pub. No.: US 2019/0253119 A1
(43) Pub. Date: Aug. 15, 2019

(54) CHANNEL STATUS INFORMATION REPORTING METHOD AND DETECTING METHOD AND COMMUNICATION DEVICE AND BASE STATION THEREFOR

(71) Applicant: INDUSTRIAL TECHNOLOGY RESEARCH INSTITUTE, Hsinchu (TW)

(72) Inventors: Li-Chung LO, Taichung City (TW); Chien-Min LEE, Taoyuan City (TW)

(73) Assignee: INDUSTRIAL TECHNOLOGY RESEARCH INSTITUTE, Hsinchu (TW)

(21) Appl. No.: 16/272,344

(22) Filed: Feb. 11, 2019

Related U.S. Application Data
(60) Provisional application No. 62/629,724, filed on Feb. 13, 2018.

(30) Foreign Application Priority Data
Dec. 20, 2018 (TW) 107146198

(51) Int. Cl. H04B 7/06; H04L 5/00; H04W 24/10; H04W 72/04

(52) U.S. Cl. CPC H04B 7/0626; H04L 5/0051; H04W 24/10; H04L 5/001; H04W 72/0453; H04B 7/0617; H04L 5/0023; H04W 72/046

(57) ABSTRACT

A channel status information (CSI) reporting method used in a communication device of a wireless communication system includes the following steps. At least one first reference signal corresponding to a first serving cell is received. Channel measurement on each of the first reference signals is performed. A candidate reference signal is obtained according to a result of the channel measurement of the at least one first reference signal. Channel status information corresponding to the candidate reference signal is reported.

This application claims the benefit of U.S. provisional application Ser. No. 62/629,724, filed Feb. 13, 2018 and Taiwan application Serial No. 107146198, filed Dec. 20, 2018, the disclosure of which is incorporated by reference herein in its entirety.

### TECHNICAL FIELD

This disclosure relates to a channel status information reporting method and detecting method, and a communication device and a base station therefor.

### BACKGROUND

The carrier aggregation (CA) technology can be used to improve the data transmission rate, and to provide sufficient frequency resources for transmission of burst data. Therefore, the carrier aggregation technology is continuously and flourishingly developed in the field of new radio (NR).

However, how to use a beam management framework when services (e.g., operating at frequencies above 6 GHz) are provided on multiple serving cells needs to be solved. More particularly, a user equipment (UE) may not simultaneously receive different transmitting beams on different serving cells, so that the carrier aggregation technology cannot be used to improve the data transmission efficiency. Therefore, how to solve the above-mentioned problems and improve the data transmission rate in the system using the carrier aggregation technology is one of the directions of the industry.

### SUMMARY

According to one embodiment of this disclosure, a channel status information reporting method used in a communication device of a wireless communication system is provided. The method includes the following steps. At least one first reference signal corresponding to a first serving cell is received. Channel measurement is performed on each of the at least one first reference signal. A candidate reference signal according to a result of the channel measurement of the at least one first reference signal is obtained. Channel status information corresponding to the candidate reference signal is reported.

According to another embodiment of this disclosure, a channel status information detecting method used in a base station of a wireless communication system is provided. The method includes the following steps. At least one first reference signal corresponding to a first serving cell is transmitted. Channel measurement is performed on each of the at least one first reference signal in a communication device of the wireless communication system, and a candidate reference signal is received after the candidate reference signal is obtained according to a result of the channel measurement of the at least one first reference signal. Channel status information corresponding to the candidate reference signal is received.

According to an alternative embodiment of this disclosure, a communication device for reporting channel status information is provided. The communication device includes a transceiving unit and a processor. The transceiving unit receives at least one first reference signal corresponding to a first serving cell. The processor is electrically connected to the transceiving unit, performs channel measurement on each of the at least one first reference signal, and obtains a candidate reference signal according to a result of the channel measurement of the at least one first reference signal. The processor further reports channel status information corresponding to the candidate reference signal through the transceiving unit.

According to another alternative embodiment of this disclosure, a base station for detecting channel status information is provided. The base station includes a transceiving unit and a processor. The transceiving unit transmits at least one first reference signal corresponding to a first serving cell. The processor is electrically connected to the transceiving unit, receive the candidate reference signal through the transceiving unit after channel measurement on each of the at least one first reference signal in a communication device of a wireless communication system is performed and a candidate reference signal is obtained according to a result of the channel measurement of the at least one first reference signal. The processor further receives the channel status information corresponding to the candidate reference signal through the transceiving unit.

### BRIEF DESCRIPTION OF THE DRAWINGS

FIG. 1A is a schematic view showing a wireless communication system for communication by using a primary component carrier.

FIG. 1B is a schematic view showing the wireless communication system for communication by using a secondary component carrier.

FIG. 2 is a schematic view showing a beam management procedure.

FIG. 3A is a schematic view showing a user equipment having one set of analog beamforming.

FIG. 3B is a schematic view showing the user equipment having two sets of analog beamforming.

FIGS. 4A to 4D are schematic views showing an example, in which the user equipment cannot simultaneously perform the receiving operation of the downlink transmission on multiple serving cells.

FIG. 5 is a schematic view showing that data transmitted on serving cells CC0 and CC1 corresponding to FIGS. 4A to 4D is received.

FIG. 6 is a flow chart showing a channel status information reporting method according to an embodiment of this disclosure.

FIGS. 7A and 7B are schematic views showing the wireless communication system corresponding to the flow chart of FIG. 6.

FIGS. 8A to 8C are schematic views showing an example of applying the channel status information reporting method of FIG. 6 of the embodiment of this disclosure.

FIGS. 9A to 9C are schematic views showing another example of applying of the channel status information reporting method of FIG. 6 of the embodiment of this disclosure.

FIGS. 10A to 10C are schematic views showing still another example of applying of the channel status information reporting method of FIG. 6 of the embodiment of this disclosure.

FIGS. 11A to 11E are schematic views showing yet still another example of applying of the channel status information reporting method of FIG. 6 of the embodiment of this disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The embodiment of this disclosure allows a base station (e.g., a 5G base station (next Generation Node B, gNodeB)) to obtain whether a user equipment (UE) can perform downlink (DL) to receive data simultaneously through multiple serving cells. The multiple serving cells operate at frequencies above 6 GHz, for example. The user equipment receives data by a physical downlink share channel (PDSCH), for example.

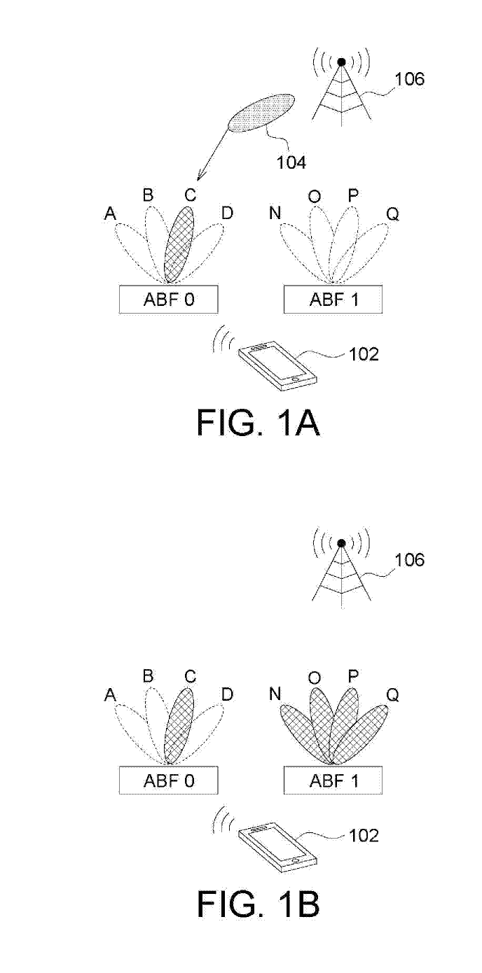

Please refer to FIGS. 1A and 1B. FIG. 1A is a schematic view showing a system for wireless communication by using a primary component carrier (PCC), and FIG. 1B is a schematic view showing the system for wireless communication by using a secondary component carrier (SCC). As shown in FIG. 1A, it is assumed that a user equipment 102 has two sets of antenna systems, and has two sets of analog beamforming (ABF) ABF0 and ABF1. Each of the analog beamforming has four receiving beams in different directions, for example. For example, the analog beamforming ABF0 has receiving beams A, B, C and D, and the analog beamforming ABF1 has receiving beams N, O, P and Q.

It is assumed that after a first beam management (BM) procedure is performed, the user equipment 102 determines to use the receiving beam C of the analog beamforming ABF0 to receive a reference signal 104 of the primary component carrier to perform the receiving operation of the downlink on the primary component cardrier of a base station 106. Different reference signals are, for example, transmitting beams directing to different directions. As shown in FIG. 1B, after the first beam management procedure is performed, the user equipment 102 can determine to use one of the receiving beam C of the analog beamforming ABF0 and the receiving beams N, O, P and Q of the analog beamforming ABF1 to receive the reference signal of the secondary component carrier and to perform the receiving operation of the downlink on the secondary component carrier of the base station 106. Thus, when the receiving operation of the downlink is formally performed, the user equipment 102 can simultaneously receive data transmitted on the primary component carrier and the secondary component carrier. That is, for example, the user can simultaneously use the receiving beam C of the analog beamforming ABF0 to receive the data transmitted on the primary component carrier and the secondary component carrier, or use the receiving beam C of the analog beamforming ABF0 to receive the data transmitted on the primary component carrier and use one of the receiving beams N, O, P and Q of the analog beamforming ABF1 to receive the data transmitted on the secondary component carrier. In this manner, the data transmission rate can be effectively improved.

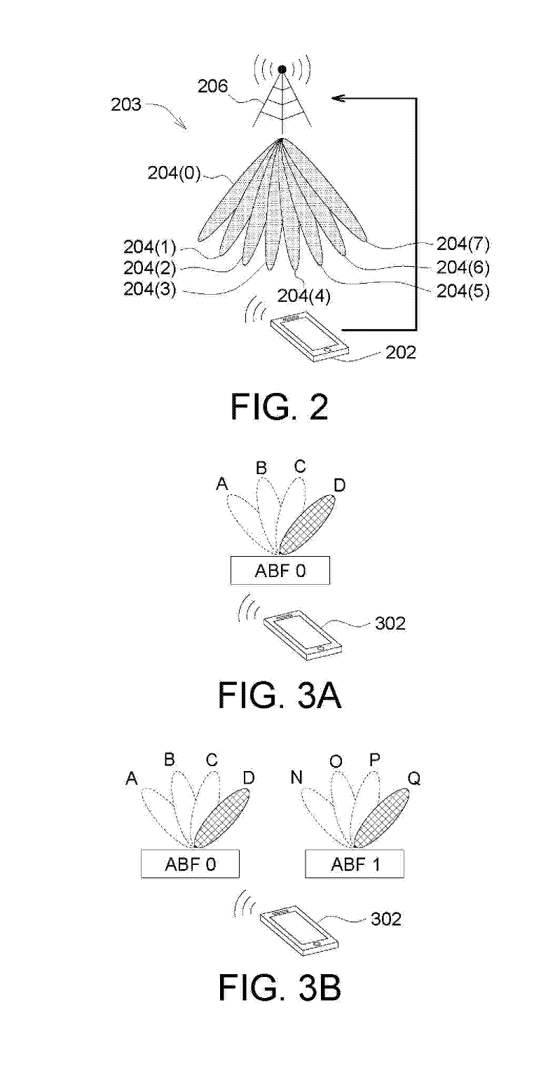

The above-mentioned beam management procedure is briefly explained as follows. FIG. 2 is a schematic view showing the beam management procedure. Referring to FIG. 2, it is assumed that a base station 206 cannot obtain the associated message of the receiving beam used by a user equipment 202. That is, the base station 206 cannot know which receiving beam is used by the user equipment 202 to receive the reference signal transmitted by the base station 206. Under this situation, the base station and the user equipment independently perform the beam management procedures on each serving cell.

A general beam management procedure mainly includes the following three steps. First, the base station 206 provides a reference signal configuration for the beam management procedure. That is, for each serving cell, the user equipment 202 can be configured with at least one reference signal configuration used in the management or measurement for the beam or channel status information. For example, as shown in FIG. 2, the base station 206 provides the reference signal configuration 203 including reference signals 204(0) to 204(7).

Second, the beam measurement is performed. That is, for each serving cell, the user equipment 202 can perform the management or measurement for beam or channel status information (CSI) according to the above-mentioned reference signal configuration. For example, for the reference signals 204(0) to 204(7) in the reference signal configuration 203, the user equipment 202 can respectively perform the management or measurement for the beam or channel status information by using the corresponding receiving beams to obtain the signal intensities or signal qualities of the received reference signals 204(0) to 204(7).

Third, the beam reporting is performed. The beam reporting includes a report indicating which beam and the corresponding measurement quality. That is, for each serving cell, the user equipment 202 can report management or measurement results according to the reference signal configuration. For example, the user equipment 202 can select one of the reference signals 204(0) to 204(7) which has the best signal intensity or signal quality for reporting, and report the corresponding signal quality.

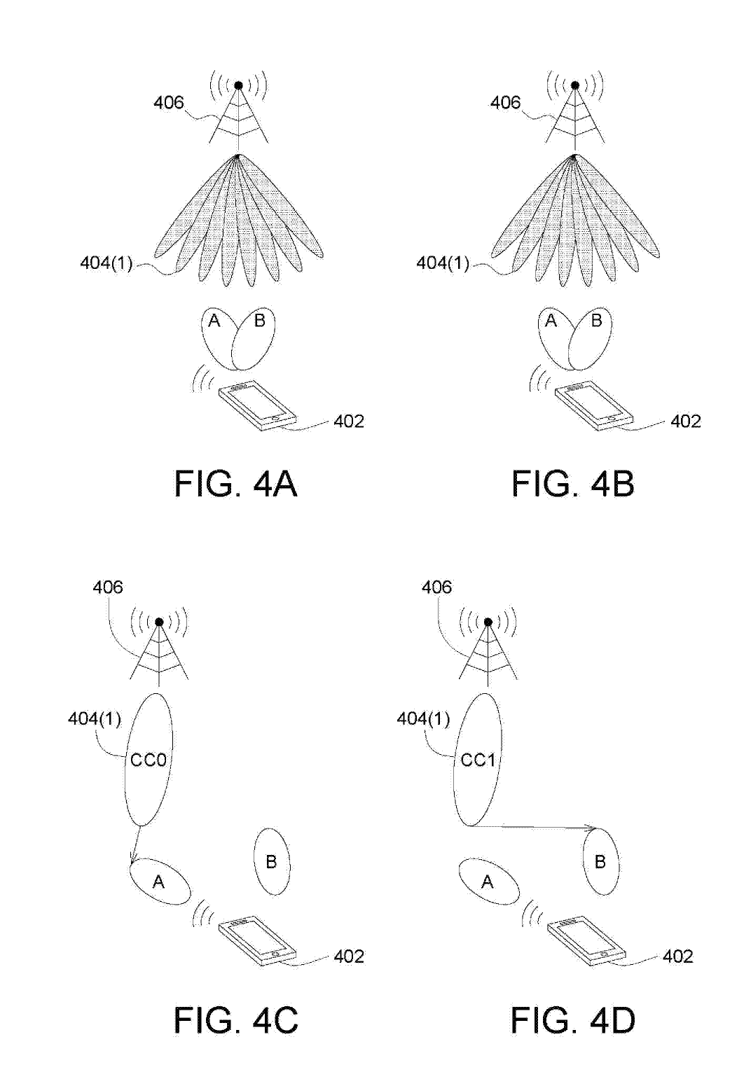

The above-mentioned analog beamforming is briefly explained as follows. FIG. 3A is a schematic view showing a user equipment having one set of analog beamforming, and FIG. 3B is a schematic view showing the user equipment having two sets of analog beamforming. Referring to FIGS. 3A and 3B, the analog beamforming ABF0 has a second sets of receiving beams (i.e., the receiving beams A, B, C and D), and the analog beamforming ABF1 has a first set of receiving beams (i.e., the receiving beams N, O, P and Q). For the analog beamforming ABF0, a user equipment 302 may need to receive the data transmitted through the receiving beams A, B, C and D in time-division multiplex (TDM) manner. For the analog beamforming ABF1, the user equipment 302 may also need to receive the data transmitted through the receiving beams N, O, P and Q in the TDM manner. For each set of receiving beams, the signal is received through at most one receiving beam on the side of the user equipment 302. However, the user equipment 302 can simultaneously perform the receiving operation of the downlink on different sets (e.g., the first set and the second set). Different user equipments may have different antenna patterns, abilities, configurations or any combination thereof. However, the base station may not obtain the number of receiving beams of the user equipment and the relationship between the receiving beams.

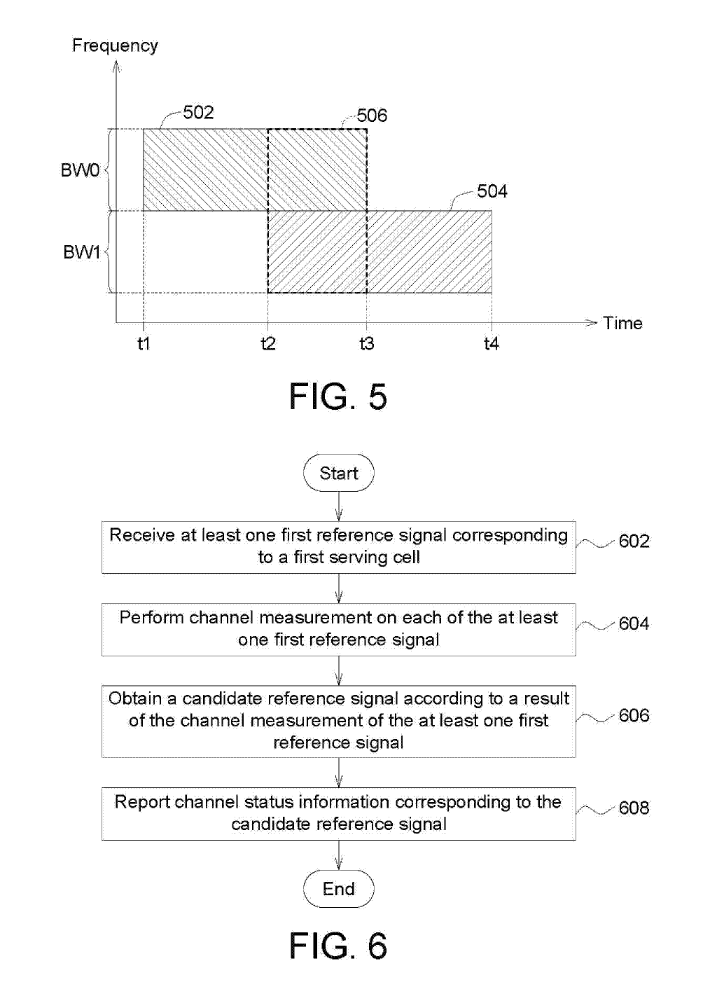

However, the user equipment may still have the situation that it cannot simultaneously perform the receiving operation of the downlink from multiple serving cells. Please refer to FIGS. 4A to 4D, which are schematic views showing an example, in which the user equipment cannot simultaneously perform the receiving operation of the downlink from multiple serving cells. As shown in FIG. 4A, it is assumed that after the beam management procedure is performed, a user equipment 402 selects a reference signal 404(1) with regard to the serving cell CC0 and reports a base station 406, wherein the user equipment 402 receives the reference signal 404(1) through the receiving beam A.

As shown in FIG. 4B, it is assumed that after the beam management procedure is performed, the user equipment 402 selects the reference signal 404(1) with regard to the serving cell CC1 and reports the base station 406, wherein the user equipment 402 receives the reference signal 404(1) through the receiving beam B.

Next, when the data is formally transmitted, as shown in FIG. 4C, the base station 406 may use the reference signal 404(1) to perform data transmission on the serving cell CC0, and the user equipment 402 receives the data transmitted on the reference signal 404(1) through the receiving beam A. In addition, when the data is formally transmitted, as shown in FIG. 4D, the base station 406 may also use the reference signal 404(1) to perform data transmission on the serving cell CC1, and the user equipment 402 receives the data transmitted on the reference signal 404(1) through the receiving beam B. However, when the user equipment 402 receives the data of the reference signal 404(1) on the serving cells CC0 and CC1, different receiving beams A and B are respectively used. So, there will be a problem that the data transmitted on the serving cells CC0 and CC1 cannot be simultaneously received by the receiving beams A and B.

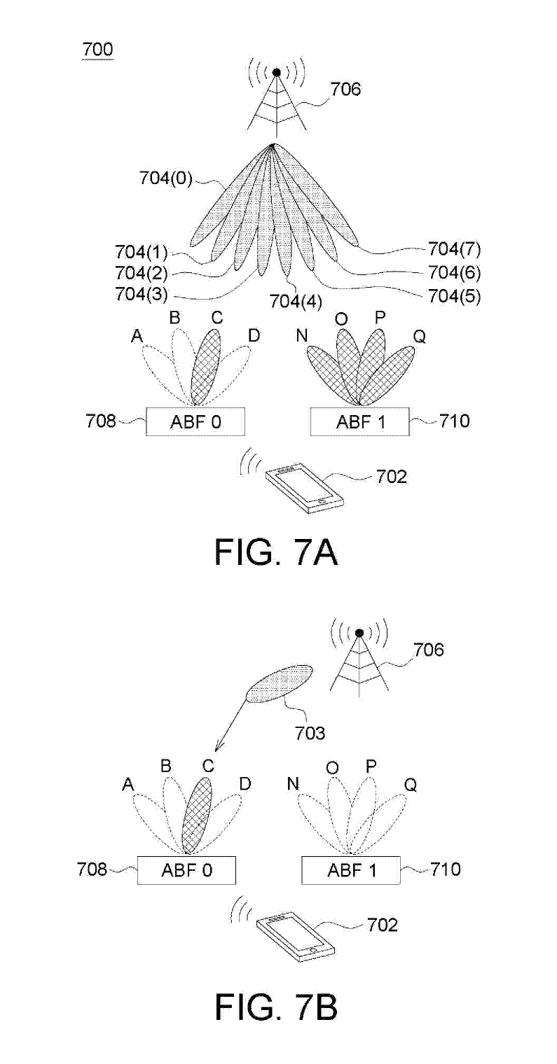

Please refer to FIG. 5, which is a schematic view showing that data transmitted on serving cells CC0 and CC1 corresponding to FIGS. 4A to 4D is received. It is assumed that at the time between time points t1 to t3 (as indicated by an area 502), the base station 406 transmits the data by the serving cell CC0 corresponding to the frequency band BW0, and the user equipment 402 uses the receiving beam A corresponding to the reference signal 404(1) to receive the data. It is assumed that at the time between time points t2 to t4 (as indicated by an area 504), the base station 406 transmits the data by the serving cell CC1 corresponding to the frequency band BW1, and the user equipment 402 uses the receiving beam B corresponding to the reference signal 404(1) to receive the data. However, at the time between the time points t2 and t3 (as indicated by an area 506), because the user equipment 402 can only use the receiving beam A or B to receive the data, the user equipment 402 can only receive the data transmitted by the serving cell CC0 from the base station 406, or the data transmitted by the serving cell CC1 from the base station 406, and the user equipment 402 cannot simultaneously receive the data transmitted by the serving cells CC0 and CC1. Another possibility is that a user equipment uses the receiving beam A or B to simultaneously receive the data of the serving cell CC0 and the serving cell CC1. In this condition, however, one of the serving cells (CC0 or CC1) may have the poor data receiving quality. Thus, the effect that the carrier aggregation technologies of the serving cells CC0 and CC1 are simultaneously used to improve the data transmission rate cannot be achieved, and sufficient frequency resources for the transmission of burst data cannot be provided.

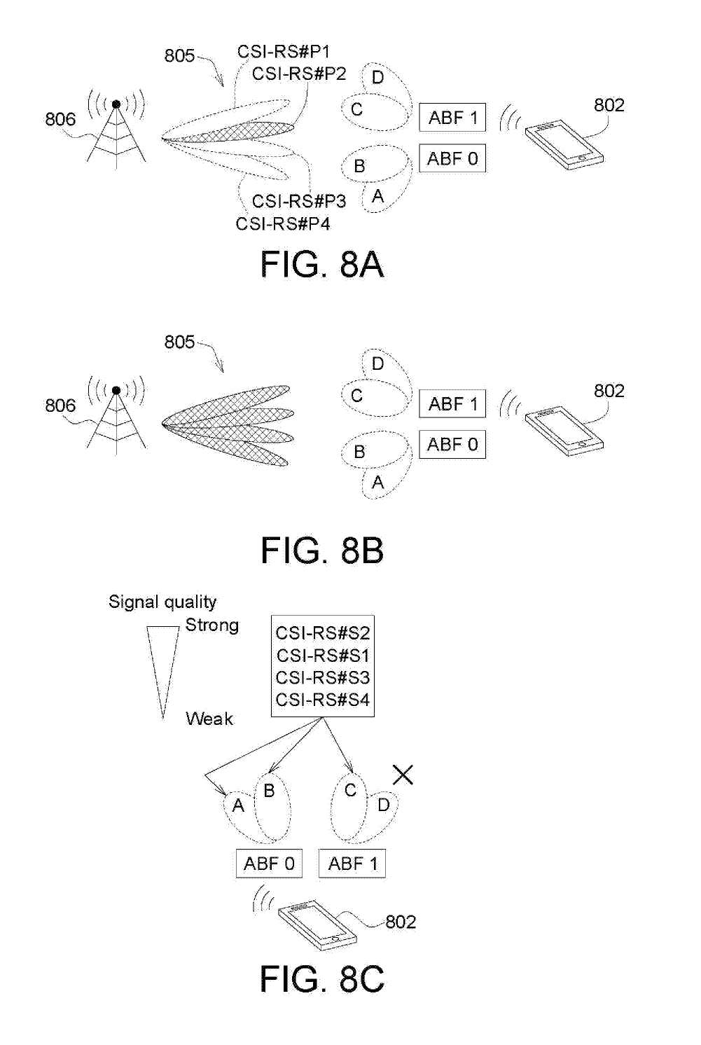

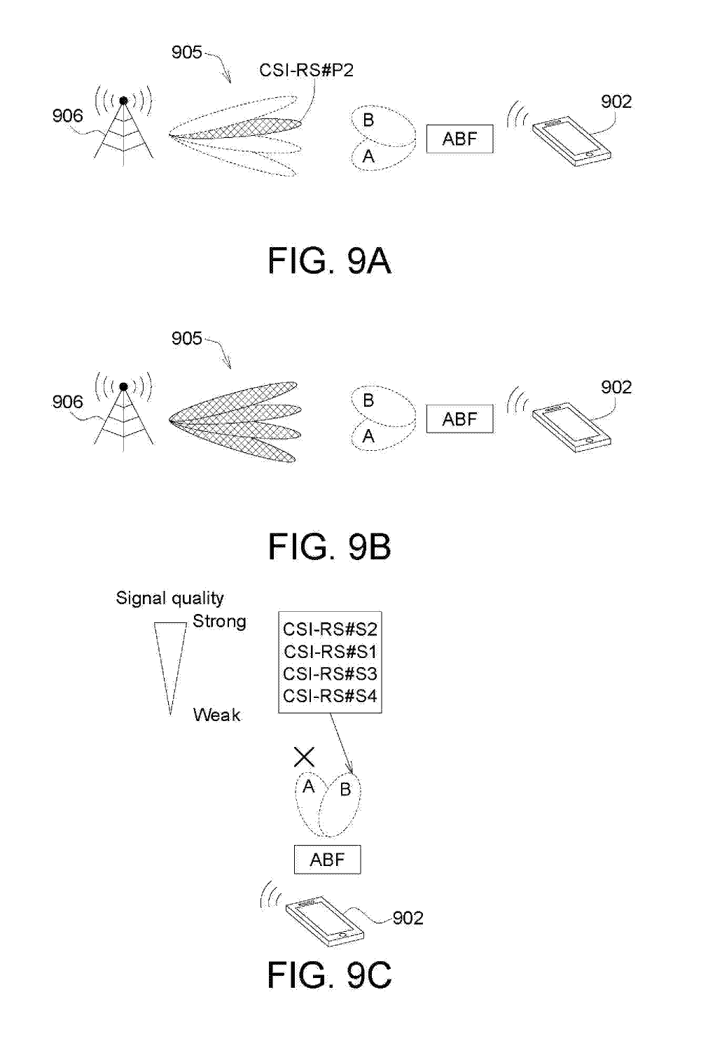

In order to solve the above-mentioned problem, the embodiment of this disclosure provides a channel status information reporting method of the wireless communication system. FIG. 6 is a flow chart showing a channel status information reporting method according to an embodiment of this disclosure. FIGS. 7A and 7B are schematic views showing the wireless communication system corresponding to the flow chart of FIG. 6. The method is used in a communication device 702 of a wireless communication system 700.

The channel status information reporting method of this embodiment includes the following steps. In a step 602, at least one first reference signal corresponding to a first serving cell is received, as shown in FIG. 7A. Next, in a step 604, channel measurement is performed on each of the at least one first reference signal.

Then, in a step 606, a candidate reference signal is obtained according to a result of the channel measurement of the at least one first reference signal. Then, in a step 608, channel status information corresponding to the candidate reference signal is reported. The relevant parts will be further described later.

The above-mentioned channel status information reporting method further includes a step of receiving at least one serving cell identifier and/or a reference signal configuration (e.g., for reference). The above-mentioned at least one first reference signal is associated with the at least one serving cell identifier and/or the reference signal configuration for reference.

The at least one serving cell identifier and/or the reference signal configuration for reference corresponds to a second serving cell. The communication device 702 has at least one spatial domain receive filter. In the step 604 of performing the channel measurement on each of the at least one first reference signal, the channel measurement is performed by selecting at least a part of the at least one spatial domain receive filter capable of performing simultaneously receiving together with the second serving cell, or by selecting at least a part of the at least one spatial domain receive filter capable of performing simultaneously receiving together with the reference signal configuration for reference.

The above-mentioned reference signal configuration for reference is, for example, quasi co-location (QCL) with the candidate reference signal. For example, the above-mentioned reference signal configuration for reference and the candidate reference signal QCL means that when the user equipment (UE) uses a specific receiving beam to receive the reference signal configuration for reference, the user equipment also uses the specific receiving beam to receive the candidate reference signal. A definition of the QCL may refer to the definition of 3rd Generation Partnership Project (3GPP) Long Term Evolution (LTE) or 3GPP NR specification.

As shown in FIG. 7B, a first spatial domain receive filter of the communication device 702 of the wireless communication system 700 receives a second reference signal (e.g., a reference signal 703) of the second serving cell. A base station 706 of the wireless communication system 700 is used to communicate with the communication device 702 which using the first spatial domain receive filter by using the second reference signal (e.g., the reference signal 703) of the second serving cell and. The candidate reference signal is associated with the above-mentioned first spatial domain receive filter. The second reference signal and the candidate reference signal are, for example, quasi co-location correlations. For example, when the user equipment uses a specific receiving beam to receive the second reference signal, the user equipment also uses the specific receiving beam to receive the candidate reference signal.

The spatial domain receive filter is achieved by, for example, an antenna plate for generating an analog beam pattern having multiple beams. The beam in this disclosure can be achieved by an antenna, an antenna port, an antenna element, a set of antennas, a set of antenna ports, a set of antenna elements, or a spatial domain filter. An antenna panel has at least one antenna, at least one antenna port or at least one antenna element, for example. By processing at least one antenna signal received by the at least one antenna, the at least one antenna port, or the at least one antenna element of the antenna panel (e.g., multiplied by different phase rotation values), the above-mentioned at least one spatial domain filter can be implemented to achieve the above-mentioned function of the receiving beam capable of receiving the signals in different directions.

In the above-mentioned method, the base station 706 can respectively use the candidate reference signal and the second reference signal to communicate with the communication device 702 on the first serving cell and the second serving cell simultaneously. The first serving cell is, for example, a secondary serving cell; and the second serving cell is, for example, a primary serving cell. Alternatively, the second serving cell is a serving cell predetermined by the base station 706, and the first serving cell is a serving cell different from the second serving cell. In an embodiment, different serving cells correspond to different signal transmission frequency bands, or different component carriers. In another embodiment, different serving cells may also use the same or different signal transmission frequency bands, but use the time-division multiplexing method to transmit data over different time periods. In still another embodiment, different serving cells use different encoding methods to transmit data.

The communication device 702 is, for example, the user equipment. The above-mentioned at least one first reference signal includes, for example, reference signals 704(0) to 704(7). In the first serving cell (e.g., the secondary serving cell), for example, communication is performed by the secondary component carrier. In the second serving cell (e.g., the primary serving cell), for example, communication is performed by the primary component carrier, or by the component carrier specified by the base station (e.g., an upper layer signal is used). The above-mentioned at least one serving cell identifier is, for example, a serving cell identifier of the second serving cell (e.g., the primary serving cell), or the serving cell identifier of the serving cell configured or specified by the base station. The above-mentioned reference signal configuration for reference is, for example, the reference signal configuration corresponding to all reference signals of the second serving cell.

The above-mentioned candidate reference signal associating with the first spatial domain receive filter means that when the communication device 702 receives the second reference signal from the base station 706 using the first spatial domain receive filter on the second serving cell, the communication device 702 may also receive the candidate reference signal from the base station 706 using the first spatial domain receive filter. Alternatively, when the communication device 702 receives the second reference signal from the base station 706 using the first spatial domain receive filter on the second serving cell, the communication device 702 may also receive the candidate reference signal from the base station 706 using other spatial domain receive filters different from the first spatial domain receive filter. Thus, the base station 706 can respectively use the candidate reference signal and the second reference signal to communicate with the communication device 702 on the first serving cell and the second serving cell simultaneously.

For example, it is assumed that the first spatial domain receive filter corresponds to the receiving beam C. When the base station 706 uses the second serving cell to communicate with the communication device 702, the base station 706 uses the reference signal 703 to communicate with the receiving beam C of the communication device 702. However, the receiving beams for receiving the candidate reference signal may be the receiving beam C belonging to the analog beamforming ABF0, or one of the receiving beams N, O, P and Q belonging to the analog beamforming ABF1. Thus, the communication device 702 can receive the reference signal 703 and the candidate reference signal (may be one of the reference signals 704(0) to 704(7)) from the base station 706 simultaneously by using the receiving beam C. Alternatively, the communication device 702 may receive the reference signal 703 from the base station 706 by using the receiving beam C, and receive the candidate reference signal (which may be one of the reference signals 704(0) to 704(7)) from the base station 706 simultaneously by using one of the receiving beams N, O, P and Q to achieve the purpose that the downlink is performed between the base station 706 and the communication device 702 simultaneously by using the second serving cell (e.g., corresponding to the primary component carrier) and the first serving cell (e.g., corresponding to the secondary component carrier).

One of the embodiments for achieving the above-mentioned purposes may be achieved by way of limiting upon measurement. For example, assume that the communication device has a first antenna panel 708 and a second antenna panel 710. The first antenna panel 708 is used to generate the first spatial domain receive filter (e.g., corresponding to the receiving beam C) and at least one second spatial domain receive filter (e.g., corresponding to the receiving beams A, B and D), and the second antenna panel 710 is used to generate at least one third spatial domain receive filter (e.g., corresponding to the receiving beams N, O, P and Q). In the step 606 of obtaining the candidate reference signal according to the result of the channel measurement of the at least one first reference signal, the reference signal received by the at least one second spatial domain receive filter (e.g., corresponding to the receiving beams A, B and D) is not selected and used to function as the candidate reference signal. For example, the reference signal received by the first spatial domain receive filter (e.g., corresponding to the receiving beam C) of the first antenna panel 708, or the reference signal received by the third spatial domain receive filter (e.g., corresponding to the receiving beams N, O, P and Q) of other antenna panels (e.g., the antenna panel 710) is selected and used to function as the candidate reference signal. That is, in the step 604 of performing the channel measurement on each of the first reference signals (reference signals 704(0) to 704(7)), only the first spatial domain receive filter (e.g., corresponding to the receiving beam C) of the first antenna panel 708, or the third spatial domain receive filter (e.g., corresponding to the receiving beams N, O, P and Q) of other antenna panels (e.g., the antenna panel 710) is used to perform the channel measurement. The reference signal received by the first spatial domain receive filter (e.g., corresponding to the receiving beam C) and the reference signal received by the third spatial domain receive filter (e.g., corresponding to the receiving beams N, O, P and Q) are selected and used to function as the candidate reference signal.

Another embodiment for achieving the above-mentioned purposes may be achieved by way of limiting upon reporting. For example, in the step 608 of reporting the channel status information corresponding to the candidate reference signal, the channel status information of the reference signal received by using at least one second spatial domain receive filter (e.g., corresponding to the receiving beams A, B and D) is not reported. For example, the channel status information of the reference signal received by the second spatial domain receive filters (e.g., corresponding to the receiving beams A, B and D) is not reported. That is, in the step 608 of reporting the channel status information corresponding to the candidate reference signal, the channel status information of the reference signal received by using the first spatial domain receive filter (e.g., corresponding to the receiving beam C) is reported. Alternatively, only the channel status information of the reference signal received by using the first spatial domain receive filter (e.g., corresponding to receiving beam C) of the first antenna panel 708, or the channel status information of the reference signal received by using the third spatial domain receive filter (e.g., corresponding to the receiving beams N, O, P and Q) of other antenna panels (e.g., the antenna panel 710) is reported.

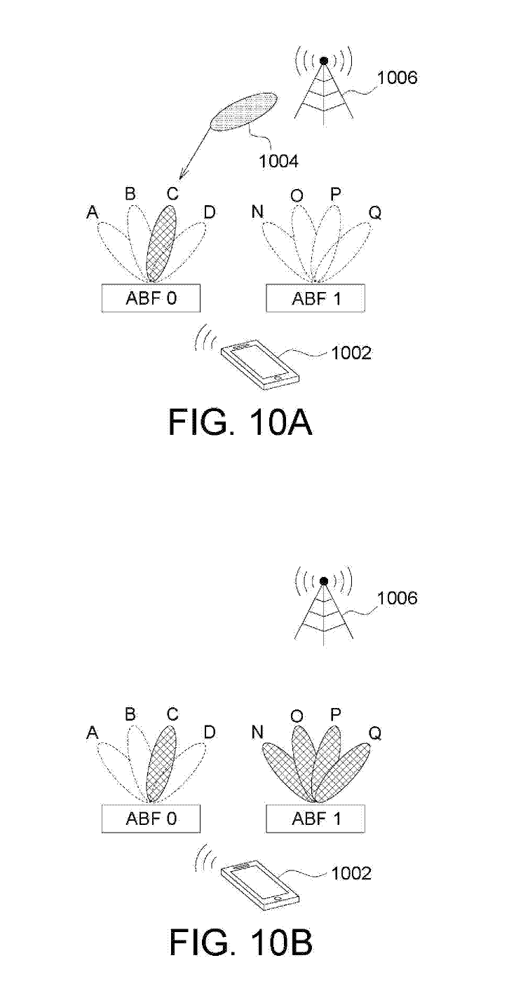

An example will be taken to provide the further detailed explanation. Please refer to FIGS. 8A to 8C, which are schematic views showing an example of applying of the channel status information reporting method of FIG. 6 of the embodiment of this disclosure. To simplify the explanation, it is assumed that a communication device 802 has analog beam patterns ABF0 and ABF1, wherein the analog beam pattern ABF0 has receiving beams A and B, and the analog beam pattern ABF1 has receiving beams C and D.

As shown in FIG. 8A, when the beam management procedure is performed on the second component carrier (e.g., the primary component carrier), it is assumed that a base station 806 transmits four reference signals CSI-RS#P1, CSI-RS#P2, CSI-RS#P3 and CSI-RS#P4 representing the four reference signals from top to bottom. The CSI-RS represents a channel status information reference signal. It is assumed that when the base station 806 uses the second component carrier (e.g., the primary component carrier) to communicate with the communication device 802, the base station 806 selects the reference signal CSI-RS#P2 and uses the reference signal CSI-RS#P2 to communicate with the receiving beam C of the communication device 802.

As shown in FIG. 8B, when the beam management procedure is performed on the first component carrier (e.g., the secondary component carrier), the communication device 802 receives at least one of reference signals CSI-RS#S1, CSI-RS#S2, CSI-RS#S3 and CSI-RS#S4 (representing four reference signals from top to bottom) of a reference signal configuration 805 corresponding to the first component carrier (e.g., the secondary component carrier). Next, the channel measurement is performed on each of the reference signals CSI-RS#S1, CSI-RS#S2, CSI-RS#S3 and CSI-RS#S4.

As shown in FIG. 8C, when the channel measurement is performed, the method of limiting upon measurement is adopted. That is, when the channel measurement is performed on each of the reference signals CSI-RS#S1, CSI-RS#S2, CSI-RS#S3 and CSI-RS#S4, the receiving beam D is not used for the channel measurement. That is, when the channel measurement is performed on each of the reference signals CSI-RS#S1, CSI-RS#S2, CSI-RS#S3 and CSI-RS#S4, only the receiving beam C of the analog beam pattern ABF1, or the receiving beams A and B of the analog beam pattern ABF0 are used for the channel measurement.

It is assumed that after the channel measurement is performed on each of the reference signals CSI-RS#S1, CSI-RS#S2, CSI-RS#S3 and CSI-RS#S4, the intensity order of the signal quality of each reference signal obtained is CSI-RS#S2, CSI-RS#S1, CSI-RS#S3, and CSI-RS#S4 from high to low. Then, the CSI-RS#S2 with the strongest signal quality is selected and used to function as the candidate reference signal according to a result of the channel measurement and is reported to the base station 806, and the channel status information corresponding to the candidate reference signal CSI-RS#S2 may be further reported to the base station 806. The communication device 802 may only report the index of the reference signal CSI-RS, such as one of the indexes S1 to S4.

Therefore, the purpose that the downlink transmission is performed simultaneously between the base station 806 and the communication device 802 by using the second component carrier (e.g., the primary component carrier) and the first component carrier (e.g., the secondary component carrier) simultaneously can be achieved.

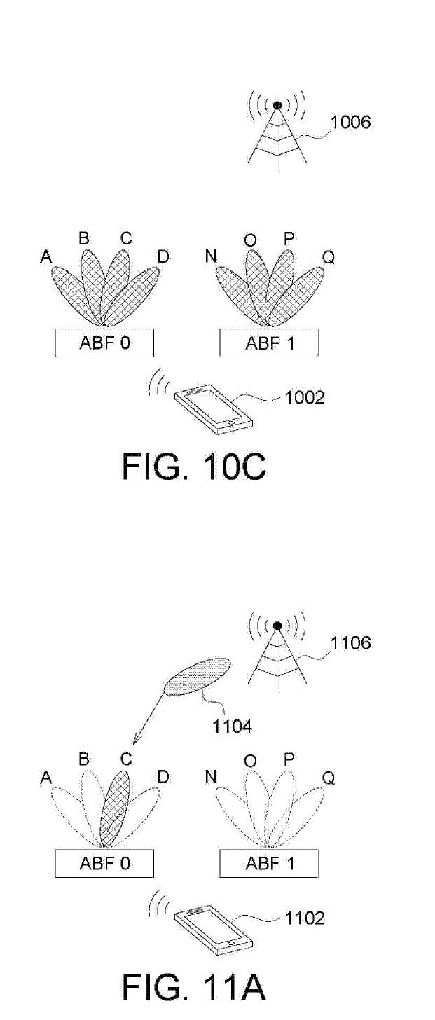

Another example will be taken to provide the further detailed explanation. Please refer to FIGS. 9A to 9C, which are schematic views showing another example of applying of the channel status information reporting method of FIG. 6 of the embodiment of this disclosure. What is different from FIGS. 8A to 8C is that a communication device 902 only has one analog beam pattern ABF. As shown in FIG. 9A, it is assumed that when a base station 906 uses the second component carrier (e.g., the primary component carrier) to communicate with the communication device 902, the base station 906 selects the reference signal CSI-RS#P2 of a reference signal configuration 905 and use the reference signal CSI-RS#P2 of a reference signal configuration 905 to communicate with the receiving beam B of the communication device 902. As a result, the method of limiting upon performing the channel measurement on the second component cardrier may be the following method. As shown in FIGS. 9B and 9C, when the channel measurement is performed on each of the reference signals CSI-RS#S1, CSI-RS#S2, CSI-RS#S3 and CSI-RS#S4, the receiving beam A is not used for channel measurement, and only the receiving beam B is used for channel measurement. Therefore, the purpose that the downlink transmission is performed simultaneously between the base station 906 and the communication device 902 by using the second component carrier (e.g., the primary component carrier) and the first component carrier (e.g., the secondary component carrier) simultaneously can also be achieved.

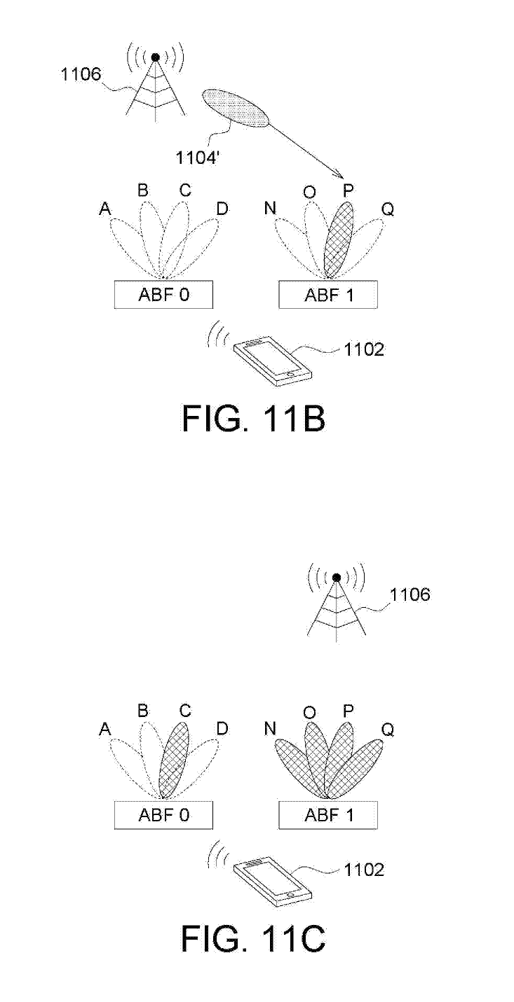

The channel status information reporting method of the wireless communication system of the embodiment of this disclosure further includes a step of reporting a flag. The flag indicates whether the above-mentioned candidate reference signal is associated with the first spatial domain receive filter or not. An example will be described in the following. Please refer to FIGS. 10A to 10C, which are schematic views showing still another example of applying of the channel status information reporting method of FIG. 6 of the embodiment of this disclosure. What is different from FIGS. 8A to 8C is that a communication device 1002 can simultaneously report the value of the flag “Flag” when the communication device 1002 reports the candidate reference signal and the channel status information corresponding to the candidate reference signal to a base station 1006. The value of the flag “Flag” shown in FIG. 10B is the ON (e.g., 1) status, and the value of the flag “Flag” shown in FIG. 10C is the OFF (e.g., 0) status. That is, FIG. 10B shows that the selected candidate reference signal is associated with the first spatial domain receive filter (e.g., corresponding to the receiving beam C), or may be associated with the component carrier of the primary serving cell, or is associated with the component carrier of the serving cell configured or specified by the base station. For example, in the measurement and report processes for the selected candidate reference signal, the receiving beam C used to receive a reference signal 1004 in FIG. 10A is considered. That is, in FIG. 10B, when the channel measurement is performed on at least one reference signal of the first component carrier (e.g., the secondary component carrier), the receiving beams C, N to Q may be used to perform the channel measurement; while FIG. 10C shows a condition in which the selected candidate reference signal is not associated with the first spatial domain receive filter (e.g., corresponding to receiving beam C). For example, in the measurement and report processes for the selected candidate reference signal, the receiving beam C used to receive the reference signal 1004 in FIG. 10A is not considered. That is, in FIG. 10C, when the channel measurement is performed on at least one reference signal of the first component carrier (e.g., the secondary component carrier), all receiving beams A to D and N to Q may be used to perform the channel measurement.

With the use of the flag, the base station 1006 can obtain the information about whether the candidate reference signal reported by the communication device 1002 is associated with the first spatial domain receive filter (e.g., corresponding to the receiving beam C). Thus, when the base station 1006 uses the candidate reference signal to perform data transmission with the communication device 1002 on the first component carrier (e.g., the secondary component carrier), whether the second serving cell (corresponding to the second component carrier (e.g., the primary component carrier)) can be simultaneously used to perform downlink transmission can be determined.

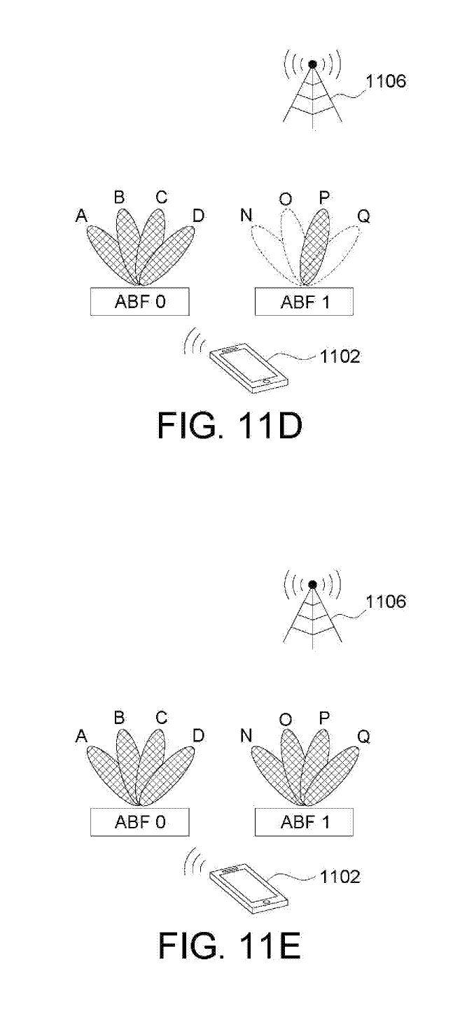

The channel status information reporting method of the wireless communication system of the embodiment of this disclosure further includes a step of reporting a parameter. The parameter indicates an index or a code of the second serving cell associated with the first spatial domain receive filter. For example, the parameter indicates that the selected candidate reference signal is associated with the index or the code of the serving cell or the component carrier, or the selected candidate reference signal is associated with the reference signal used by the primary serving cell, or the selected candidate reference signal is associated with the reference signal used by the serving cell configured or specified by the base station. An example will be described in the following. Please refer to FIGS. 11A to 11E, which are schematic views showing yet still another example of applying of the channel status information reporting method of FIG. 6 of the embodiment of this disclosure. What is different from FIGS. 8A to 8C is that a communication device 1102 can simultaneously report the value of a parameter, which indicate an index or a code of the second serving cell associated with the first spatial domain receive filter (e.g., corresponding to the receiving beam C) when the communication device 1102 reports the candidate reference signal and the channel status information corresponding to the candidate reference signal to a base station 1106.

As shown in FIG. 11A, it is assumed that the base station 1106 communicates with the receiving beam C of the communication device 1102 by using a reference signal 1104 of the second serving cell. As shown in FIG. 11B, it is assumed that the base station 1106 communicates with the receiving beam P of the communication device 1102 by using a reference signal 1104′ of a third serving cell. Thus, when the beam management procedure is performed on the first serving cell, at least one first reference signal corresponding to the reference signal configuration of the first serving cell is received; and in the process of performing the channel measurement on each of the first reference signals to obtain the candidate reference signal, the receiving beam C corresponding to the second serving cell and the receiving beam P corresponding to the third serving cell can be considered individually to obtain the candidate reference signal.

As shown in FIG. 11C, if the receiving beam C of the second serving cell is considered, then when the candidate reference signal and corresponding channel status information are reported, the index or the code of the second serving cell may be simultaneously reported. The index of the second serving cell is, for example, the identification (ID) code of the second serving cell, and the code of the second serving cell is, for example, a pre-defined value (e.g., a code 01).

As shown in FIG. 11D, if the receiving beam P of the third serving cell (e.g., other secondary serving cells except the primary serving cell and the secondary serving cell) is considered, then when the candidate reference signal and corresponding channel status information are reported, the index or the code of the third serving cell may be simultaneously reported. The index of the third serving cell is, for example, the identification (ID) code of the third serving cell, and the code of the third serving cell is, for example, a pre-defined value (e.g., a code 10).

As shown in FIG. 11E, if the receiving beam of the second serving cell or the third serving cell is not considered, then when the candidate reference signal and corresponding channel status information are reported, the index or the code of the first serving cell itself may be simultaneously reported. The index of the first serving cell is, for example, the identification (ID) code of the first serving cell, and the code of the first serving cell is, for example, a pre-defined value (e.g., a code 00).

With the use of the parameter, the base station 1106 can obtain whether the candidate reference signal reported by the communication device 1102 is associated with the second serving cell or the third serving cell. Thus, when base station 1106 uses the candidate reference signal to perform data transmission with the communication device 1102 on the first serving cell (e.g., the secondary serving cell), whether the second serving cell (e.g., the primary serving cell) or the third serving cell (another secondary serving cell) can be simultaneously used to perform downlink transmission can be determined.

In the above-mentioned example, explanation is made by taking the second serving cell as the primary serving cell, and taking the second component carrier as the primary component carrier. However, the second serving cell may also be a service cell predetermined by the base station, and the first serving cell is a serving cell different from the second serving cell. The second serving cell may also be a serving cell predetermined by the base station, or may be other serving cells of a non-primary serving cell. The second serving cell and the first serving cell are different from each other.

In addition, the first serving cell and the second serving cell (or the first component carrier and the second component carrier) may correspond to non-co-located transmission reception points (TRPs) or co-located TRPs. For the non-co-located TRPs, because the geographic distributions between the transceiving nodes (e.g., the base stations) are different, the user device may use different receiving beams to receive different transmitting beams transmitted from different transceiving nodes. For the co-located TRPs, power differences between different component carriers may still occur. Even if the data is transmitted via the same transmitting beam at the base station, and the user device receives the data with the same receiving beam, significant power differences may still occur on adjacent service cells.

The embodiment of this disclosure further proposes a channel status information detecting method used in a base station of a wireless communication system. The method includes: transmitting at least one first reference signal corresponding to a first serving cell; performing channel measurement on each of the at least one first reference signal in a communication device of the wireless communication system, and receiving a candidate reference after the candidate reference signal is obtained according to a result of the channel measurement of the at least one first reference signal; and receiving channel status information corresponding to the candidate reference signal.

The embodiment of this disclosure further provides a communication device for reporting channel status information. The communication device includes a transceiving unit and a processor. The transceiving unit receives at least one first reference signal corresponding to a first serving cell. The processor is electrically connected to the transceiving unit, the processor is configured to perform channel measurement on each of the at least one first reference signal and obtain a candidate reference signal according to a result of the channel measurement of the at least one first reference signal. The processor is further configured to report channel status information corresponding to the candidate reference signal through the transceiving unit.

The embodiment of this disclosure further provides a base station for detecting channel status information. The base station includes a transceiving unit and a processor. The transceiving unit is configured to transmit at least one first reference signal corresponding to a first serving cell. The processor is electrically connected to the transceiving unit. The processor is configured to receive the candidate reference signal through the transceiving unit after channel measurement on each of the at least one first reference signal in a communication device of a wireless communication system is performed and a candidate reference signal is obtained according to a result of the channel measurement of the at least one first reference signal. The processor is further configured to receive the channel status information corresponding to the candidate reference signal through the transceiving unit.

With the channel status information reporting method and detecting method, and the communication device and the base station therefor according to the above-mentioned embodiments of this disclosure, the multiple serving cells can be simultaneously used to improve the data transmission rate in conjunction with the carrier aggregation technology, so that sufficient frequency resources are provided for transmission of burst data to improve the transmission efficiency.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A channel status information reporting method used in a communication device of a wireless communication system, the method comprising steps of:
receiving at least one first reference signal corresponding to a first serving cell;
performing channel measurement on each of the at least one first reference signal;
obtaining a candidate reference signal according to a result of the channel measurement of the at least one first reference signal; and
reporting channel status information corresponding to the candidate reference signal.

2. The method according to claim 1, further comprising a step of:
receiving at least one reference signal configuration, wherein the at least one first reference signal is associated with the reference signal configuration.

3. The method according to claim 2, wherein the reference signal configuration corresponds to a second serving cell, the communication device has at least one spatial domain receive filter, and in the step of performing the channel measurement on each of the at least one first reference signal, the channel measurement is performed by selecting at least a part of the at least one spatial domain receive filter capable of performing simultaneous receiving together with the second serving cell, or by selecting at least a part of the at least one spatial domain receive filter capable of performing simultaneous receiving together with the reference signal configuration.

4. The method according to claim 1, further comprising a step of:
receiving at least one serving cell identifier, wherein the at least one first reference signal is associated with the at least one serving cell identifier.

5. The method according to claim 4, wherein the at least one serving cell identifier corresponds to a second serving cell, the communication device has at least one spatial domain receive filter, and in the step of performing the channel measurement on each of the at least one first reference signal, at least a part of the at least one spatial domain receive filter capable of performing simultaneous receiving together with the second serving cell is selected.

6. The method according to claim 1, wherein a first spatial domain receive filter of the communication device of the wireless communication system is configured to receive a second reference signal of a second serving cell, and the candidate reference signal is associated with the first spatial domain receive filter.

7. The method according to claim 6, wherein the communication device has a first antenna panel and a second antenna panel, the first antenna panel is configured to generate the first spatial domain receive filter and at least one second spatial domain receive filter, the second antenna panel is configured to generate at least one third spatial domain receive filter, and in the step of obtaining the candidate reference signal according to the result of the channel measurement of the at least one first reference signal and in the step of reporting the channel status information corresponding to the candidate reference signal, the reference signal received by the at least one second spatial domain receive filter is not selected and not used to function as the candidate reference signal, or the channel status information of the reference signal received by using the at least one second spatial domain receive filter is not reported.

8. The method according to claim 6, wherein the communication device can communicate with a base station on the first serving cell and the second serving cell simultaneously through the candidate reference signal and the second reference signal, respectively.

9. The method according to claim 6, further comprising a step of:
reporting a flag, wherein the flag indicates whether the candidate reference signal is associated with the first spatial domain receive filter or not.

10. The method according to claim 6, further comprising a step of:
reporting a parameter, wherein the parameter indicates an index or a code of the second serving cell associated with the first spatial domain receive filter.

11. The method according to claim 6, wherein the first serving cell is a secondary serving cell and the second serving cell is a primary serving cell, or the second serving cell is a predetermined serving cell and the first serving cell is a serving cell different from the second serving cell.

12. A channel status information detecting method used in a base station of a wireless communication system, the method comprising steps of:
transmitting at least one first reference signal corresponding to a first serving cell;
performing channel measurement on each of the at least one first reference signal in a communication device of the wireless communication system, and receiving a candidate reference signal after the candidate reference signal is obtained according to a result of the channel measurement of the at least one first reference signal; and
receiving channel status information corresponding to the candidate reference signal.

13. The method according to claim 12, further comprising a step of:
transmitting at least one reference signal configuration, wherein the at least one first reference signal is associated with the reference signal configuration.

14. The method according to claim 13, wherein the reference signal configuration corresponds to a second serving cell, the communication device has at least one spatial domain receive filter, and in the step of performing the channel measurement on each of the at least one first reference signal, the channel measurement is performed by selecting at least a part of the at least one spatial domain receive filter capable of performing simultaneous receiving together with the second serving cell, or by selecting at least a part of the at least one spatial domain receive filter capable of performing simultaneous receiving together with the reference signal configuration.

15. The method according to claim 12, further comprising a step of:
transmitting at least one serving cell identifier, wherein the at least one first reference signal is associated with the at least one serving cell identifier.

16. The method according to claim 15, wherein the at least one serving cell identifier corresponds to a second serving cell, the communication device has at least one spatial domain receive filter, and in the step of performing the channel measurement on each of the at least one first reference signal, at least a part of the at least one spatial domain receive filter capable of performing simultaneous receiving together with the second serving cell is selected.

17. The method according to claim 12, wherein a first spatial domain receive filter of the communication device of the wireless communication system is configured to receive a second reference signal of a second serving cell, and the candidate reference signal is associated with the first spatial domain receive filter.

18. The method according to claim 17, wherein the communication device has a first antenna panel and a second antenna panel, the first antenna panel is configured to generate the first spatial domain receive filter and at least one second spatial domain receive filter, the second antenna panel is configured to generate at least one third spatial domain receive filter, and in the step of receiving the candidate reference signal and in the step of receiving the channel status information corresponding to the candidate reference signal, the reference signal received by the at least one second spatial domain receive filter is not selected and used to function as the candidate reference signal, or the channel status information of the reference signal received by using the at least one second spatial domain receive filter is not reported.

19. The method according to claim 17, wherein the base station can simultaneously use the candidate reference signal and the second reference signal to communicate with the communication device on the first serving cell and the second serving cell, respectively.

20. The method according to claim 17, further comprising a step of:
receiving a flag, wherein the flag is configured to indicate whether the candidate reference signal is associated with the first spatial domain receive filter.

21. The method according to claim 17, further comprising a step of:
receiving a parameter, wherein the parameter is configured to indicate an index or a code of the second serving cell associated with the first spatial domain receive filter.

22. The method according to claim 17, wherein the first serving cell is a secondary serving cell and the second serving cell is a primary serving cell, or the second serving cell is a predetermined serving cell and the first serving cell is a serving cell different from the second serving cell.

23. A communication device for reporting channel status information, the communication device comprising:
a transceiving unit, configured to receive at least one first reference signal corresponding to a first serving cell; and
a processor, electrically connected to the transceiving unit, configured to perform channel measurement on each of the at least one first reference signal and obtain a candidate reference signal according to a result of the channel measurement of the at least one first reference signal;
wherein the processor is further configured to report channel status information corresponding to the candidate reference signal through the transceiving unit.

24. The communication device according to claim 23, wherein the transceiving unit is further configured to receive at least one reference signal configuration, wherein the at least one first reference signal is associated with the reference signal configuration.

25. The communication device according to claim 24, wherein the reference signal configuration corresponds to a second serving cell, and the communication device has at least one spatial domain receive filter, wherein when the channel measurement on each of the at least one first reference signal is performed, the channel measurement is performed by selecting at least a part of the at least one spatial domain receive filter capable of performing simultaneous receiving together with the second serving cell, or by selecting at least a part of the at least one spatial domain receive filter capable of performing simultaneous receiving together with the reference signal configuration.

26. The communication device according to claim 23, wherein the transceiving unit is further configured to receive at least one serving cell identifier, wherein the at least one first reference signal is associated with the at least one serving cell identifier.

27. The communication device according to claim 26, wherein the at least one serving cell identifier corresponds to a second serving cell, and the communication device has at least one spatial domain receive filter, wherein when the channel measurement on each of the at least one first reference signal is performed, at least a part of the at least one spatial domain receive filter capable of performing simultaneous receiving together with the second serving cell is selected.

28. The communication device according to claim 23, wherein a first spatial domain receive filter of the communication device of a wireless communication system is configured to receive a second reference signal of a second serving cell, and the candidate reference signal is associated with the first spatial domain receive filter.

29. The communication device according to claim 28, wherein the communication device has a first antenna panel and a second antenna panel, the first antenna panel is configured to generate the first spatial domain receive filter and at least one second spatial domain receive filter, and the second antenna panel is configured to generate at least one third spatial domain receive filter, wherein when the processor obtains the candidate reference signal according to a result of the channel measurement of the at least one first reference signal, and the processor reports the channel status information corresponding to the candidate reference signal through the transceiving unit, the reference signal received by the at least one second spatial domain receive filter is not selected and used to function as the candidate reference signal, or the channel status information of the reference signal received by using the at least one second spatial domain receive filter is not reported.

30. The communication device according to claim 28, wherein the communication device can communicate with a base station on the first serving cell and the second serving cell simultaneously through the candidate reference signal and the second reference signal, respectively.

31. The communication device according to claim 28, wherein the processor is further configured to report a flag through the transceiving unit, wherein the flag is configured to indicate whether the candidate reference signal is associated with the first spatial domain receive filter.

32. The communication device according to claim 28, wherein the processor is further configured to report a parameter through the transceiving unit, wherein the parameter is configured to indicate an index or a code of the second serving cell associated with the first spatial domain receive filter.

33. The communication device according to claim 28, wherein the first serving cell is a secondary serving cell and the second serving cell is a primary serving cell, or the second serving cell is a predetermined serving cell and the first serving cell is a serving cell different from the second serving cell.

34. A base station for detecting channel status information, the base station comprising:
a transceiving unit, configured to transmit at least one first reference signal corresponding to a first serving cell;
a processor, electrically connected to the transceiving unit, configured to receive the candidate reference signal through the transceiving unit after channel measurement on each of the at least one first reference signal in a communication device of a wireless communication system is performed and a candidate reference signal is obtained according to a result of the channel measurement of the at least one first reference signal; and
the processor is further configured to receive the channel status information corresponding to the candidate reference signal through the transceiving unit.

35. The base station according to claim 34, wherein the processor is further configured to transmit at least one reference signal configuration through the transceiving unit, wherein the at least one first reference signal is associated with the reference signal configuration.

36. The base station according to claim 35, wherein the reference signal configuration corresponds to a second serving cell, and the communication device has at least one spatial domain receive filter, wherein when the communication device performs the channel measurement on each of the at least one first reference signal, the channel measurement is performed by selecting at least a part of the at least one spatial domain receive filter capable of performing simultaneous receiving together with the second serving cell, or by selecting at least a part of the at least one spatial domain receive filter capable of performing simultaneous receiving together with the reference signal configuration.

37. The base station according to claim 34, wherein the processor is further configured to transmit at least one serving cell identifier through the transceiving unit, wherein the at least one first reference signal is associated with the at least one serving cell identifier.

38. The base station according to claim 37, wherein the at least one serving cell identifier corresponds to a second serving cell, and the communication device has at least one spatial domain receive filter, wherein when the communication device performs the channel measurement on each of the at least one first reference signal, at least a part of the at least one spatial domain receive filter capable of performing simultaneous receiving together with the second serving cell is selected.

39. The base station according to claim 34, wherein a first spatial domain receive filter of the communication device is configured to receive a second reference signal of a second serving cell, and the candidate reference signal is associated with the first spatial domain receive filter.

40. The base station according to claim 39, wherein the communication device has a first antenna panel and a second antenna panel, the first antenna panel is configured to generate the first spatial domain receive filter and at least one second spatial domain receive filter, and the second antenna panel is configured to generate at least one third spatial domain receive filter, wherein when the communication device obtains the candidate reference signal according to the result of the channel measurement of the at least one first reference signal and the communication device reports the channel status information corresponding to the candidate reference signal, the reference signal received by the at least one second spatial domain receive filter is not selected and used to function as the candidate reference signal, or the channel status information of the reference signal received by using the at least one second spatial domain receive filter is not reported.

41. The base station according to claim 39, wherein the base station is configured to simultaneously use the candidate reference signal and the second reference signal to communicate with the communication device on the first serving cell and the second serving cell, respectively.

42. The base station according to claim 39, wherein the processor is further configured to receive a flag through the transceiving unit, wherein the flag is configured to indicate whether the candidate reference signal is associated with the first spatial domain receive filter.

43. The base station according to claim 39, wherein the processor is further configured to receive a parameter through the transceiving unit, wherein the parameter is configured to indicate an index or a code of the second serving cell associated with the first spatial domain receive filter.

44. The base station according to claim 39, wherein the first serving cell is a secondary serving cell and the second serving cell is a primary serving cell, or the second serving cell is a predetermined serving cell and the first serving cell is a serving cell different from the second serving cell.
